(19) United States
(12) Patent Application Publication
(10) Pub. No.: US 2017/0193428 A1
(43) Pub. Date: Jul. 6, 2017

(54) METHOD, SYSTEM AND COMPUTER PRODUCT FOR IDENTIFYING, COORDINATING AND MANAGING MAIL

(71) Applicant: International Business Machines Corporation, Armonk, NY (US)

(72) Inventors: Robert M. Abrams, Wappinger Falls, NY (US); Tabari H. Alexander, Peekskill, NY (US); Yuk L. Chan, Rochester, NY (US); Susan Z. Demkowicz, Rhinebeck, NY (US); Theresa Dowden, Red Hook, NY (US); Christopher S. Loers, Poughkeepsie, NY (US)

(21) Appl. No.: 14/989,121

(22) Filed: Jan. 6, 2016

(51) Int. Cl. G06Q 10/08

(52) U.S. Cl. CPC G06Q 10/083

(57) ABSTRACT

A method, system and computer product for identifying, coordinating and managing mail includes: identifying mail packaging according to a unique identifier, the unique identifier linking the mail to a payment account, a sender and a recipient; identifying a recipient; processing deposited mail by the carrier, wherein said processing includes recognizing the unique identifier, calculation of postage of the mail and charging the postage to the payment account; and routing the mail to the recipient.

### BACKGROUND

The present invention relates to mail, and more specifically, to methods, systems and computer products for identifying, coordinating and managing mail through a unique identification code associated with a user.

United States Postal Service (USPS) mail processing is generally a well-known procedure. General information on such processing may be found at http://www.nalcbayarea.com/manualuspshandbookandmanual.htm. While we may refer to the USPS for certain non-limiting examples, we will generally refer to the category of postal carriers as “carriers.”

A typical procedure for mailing documents or other articles includes action by the sender, the carrier and the recipient. As used herein, the term “mail” will encompass any type of physical item transported by a carrier, including letter envelopes, packages and bulk items, among others.

In general, the sender will package the mail, provide recipient address and return address information, provide postage and deposit the mail in some way. A sender may provide a stamp or other pre-paid code (e.g., a bar code). Once the paid postage has been applied, the sender deposits the mail with the carrier, for example via a drop box or corporate bin.

Upon taking possession of the mail, the carrier will verify that the postage that was purchased by the sender either matches or exceeds the necessary postage based upon various parameters, including dimension, weight, destination, etc. If the pre-paid postage is not sufficient, the mail is generally returned to the sender. If the amount exceeds the required postage, the carrier typically does not issue a refund.

If the amount is sufficient, the carrier initiates transfer of the mail to a destination that is local to the recipient, for example a local distribution center or post office. Subsequently, the carrier delivers the mail according to internal or requested delivery parameters.

In certain circumstances, after the mail has been delivered to a destination that is local to the recipient, and when a recipient has an account with the carrier that enables shipping notifications and updates, the recipient may be provided an option to re-route the mail from the local carrier destination to an alternate destination of choice. Other systems allow for recipient requested re-routing or holding of mail after a first failed attempt at delivery to the listed address.

While there are benefits to current mailing protocols, e.g., with regard to notifications and optional rerouting of mail subsequent to receipt of mail at a destination that is local to the recipient, there is room for end-to-end processing improvement and increased efficiency with regard to interaction between the sender, carrier and recipient.

### SUMMARY

According to an embodiment of the present invention, a method for identifying, coordinating and managing mail includes: identifying mail packaging according to a unique identifier, the unique identifier linking the mail to a payment account, a sender and a recipient; identifying a recipient; and processing deposited mail by the carrier, wherein said processing includes recognizing the unique identifier, calculating postage of the mail and charging the postage to the payment account; and routing the mail to the recipient. In exemplary embodiments, an optimized processing carrier location provides a pre-delivery notification to the recipient and determines whether address redirection is necessary or desired in order to properly route the mail to the recipient.

According to another embodiment of the present invention, a system for identifying, coordinating and managing mail includes: a sender application configured to identify a mail packaging according to a unique identifier, the unique identifier linking the mail to a payment account, a sender and a recipient; a carrier server configured to retrieve information linked to said unique identifier during processing of the mail, calculate of postage of the mail and charge the postage to the payment account; identify the recipient; and route the mail to the recipient. In exemplary embodiments, an optimized processing carrier location provides a pre-delivery notification to the recipient and determines whether address redirection is necessary or desired in order to properly route the mail to the recipient.

According to an embodiment of the present invention, a computer product for identifying, coordinating and managing mail includes: a sender application configured to identify a mail packaging according to a unique identifier, the unique identifier linking the mail to a payment account, a sender and a recipient; a carrier server configured to retrieve information linked to said unique identifier during processing of the mail, calculate of postage of the mail and charge the postage to the payment account; identify the recipient; and route the mail to the recipient. In exemplary embodiments, an optimized processing carrier location provides a pre-delivery notification to the recipient and determines whether address redirection is necessary or desired in order to properly route the mail to the recipient.

Additional features and advantages are realized through the techniques of the present invention. Other embodiments and aspects of the invention are described in detail herein and are considered a part of the claimed invention. For a better understanding of the invention with the advantages and features, refer to the description and the drawings.

### BRIEF DESCRIPTION OF THE DRAWINGS

FIG. 1 is a front elevation view of mail, including an exemplary unique QR code and an optional recipient address field;

FIG. 2 is an exemplary flow chart describing an exemplary implementation of processing of mail with a unique identifier in accordance with the present invention;

FIG. 3 is an exemplary computer apparatus, in accordance with examples herein;

FIG. 4 is an exemplary computer system for identifying, coordinating and managing mail; and

FIG. 5 is an exemplary computer-usable medium for identifying, coordinating and managing mail.

### DETAILED DESCRIPTION

Embodiments herein are directed to methods, systems and computer products for identifying, coordinating and managing mail through a unique identification code associated with a user. The user may be a sender, recipient or third party responsible for the mail. Exemplary descriptions of methods of identifying, coordinating and managing mail immediately follow.

Further to the brief description provided above and associated textual detail of each of the figures, the following description provides additional details of example embodiments of the present invention.

Detailed illustrative embodiments are disclosed herein. However, specific functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments.

It will be understood that, although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” and the “/” symbol includes any and all combinations of one or more of the associated listed items.

As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting of example embodiments.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

An exemplary method of identifying, coordinating and managing mail includes: identifying mail packaging according to a unique identifier, the unique identifier linking the mail to a payment account, a sender and a recipient; identifying the recipient; and processing deposited mail by the carrier, wherein said processing includes recognizing the unique identifier, calculation of postage of the mail and charging the postage to the payment account; and routing the mail to the recipient.

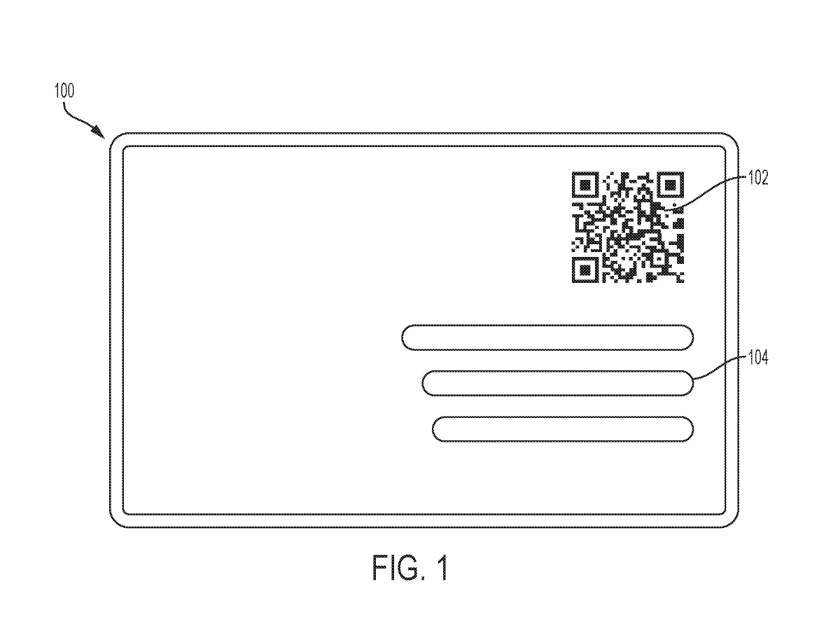

FIG. 1 is a front elevation view of mail, shown generally at 100, including a unique identifier 102, in this case a QR code, and an optional written recipient field 104. As will be described below, the unique identifier (hereinafter “identifier”) need not be a QR code, but instead may be any code or pattern that is identifiable and linkable to a payment account, a sender and a recipient, including but not limited to RFID technology. Further, as will be described in more detail below, exemplary embodiments contemplate primarily using the identifier without a recipient field, or use of both, depending on implemented carrier features. Additionally, the term “mail” should be construed to encompass any item that may be conveyed by a carrier, for example a letter envelope, a package, freight items, bulk items, etc. As will also be discussed below, the mail may include digital features that are provided along with or in parallel to physical mail.

In exemplary embodiments, an optimized processing carrier location provides a pre-delivery notification to the recipient and determines whether address redirection is necessary or desired in order to properly route the mail to the recipient. The term “optimized” should be construed to encompass an initial carrier location or a location within the chain of transportation, e.g., a processing center between an initial carrier location or drop-off and a final delivery carrier location.

In further exemplary embodiments, the unique identifier is a scan able code or pattern, for example a bar code or quick response (“QR”) code (any such scan able unique identifier will hereinafter simply be referred to as an “identifier”). In such exemplary embodiments, a sender may scan the mail with the identifier, for example using a scanning application on a mobile device, in order to associate the mail with the sender and the recipient. Subsequently, the carrier scans the mail identifier for processing of the mail, including charging the proper, correct postage to the associated payment account (in such a way thus deferring association of payment account to the identifier, avoiding security issues, loss of paid bar codes, etc.). In exemplary embodiments, the mail is solely marked with the identifier. In other exemplary embodiments, the identifier is accompanied by other identifying information, e.g., a written recipient address.

In exemplary embodiments, an envelope or other packaging, or a label, may be pre-printed with an identifier by one or more carriers for sale to customers. In other exemplary embodiments, a standard may apply across plural carriers for generating the identifiers. In alternative embodiments, the identifier may be printed by the sender.

In exemplary embodiments, a sender can flexibly associate the identifier to any authorized payment account. In exemplary embodiments utilizing a mobile scanning device, such association may be performed anytime and anywhere, without the use of a printer (e.g., where an identifier is pre-printed on an article of mail or a label).

In additional exemplary embodiments, upon scanning the unique identifier, the sender identifies the mail recipient and/or provides the recipient address. Optionally, the sender may select additional delivery services, including priority delivery, registered mail services, return receipts, selectable days to delivery, etc. Further, pre-delivery notification can be provided to the item recipient. Further, an exemplary system may be configured with resources to confirm the recipient name, address (including e.g., a recipient availability at an address) or other information or to substitute such information with different information to reflect, for example, a change in address, recipient delivery preferences, including vacation preferences, etc. Additionally, the system may be configured to accept recipient input before or after deposit of the mail with the carrier, including but not limited to: address redirection; request of a digital copy of all or a portion of the mail, or of related information relative to the mail, provision of email or mobile addresses for digital transmission, where such information is not already available, request of differential delivery, e.g., delivery of physical mail to one address with supplemental delivery of a digital version or a copy to another address. In exemplary embodiments, the carrier may be configured to scan or create digital versions or other copies of mail.

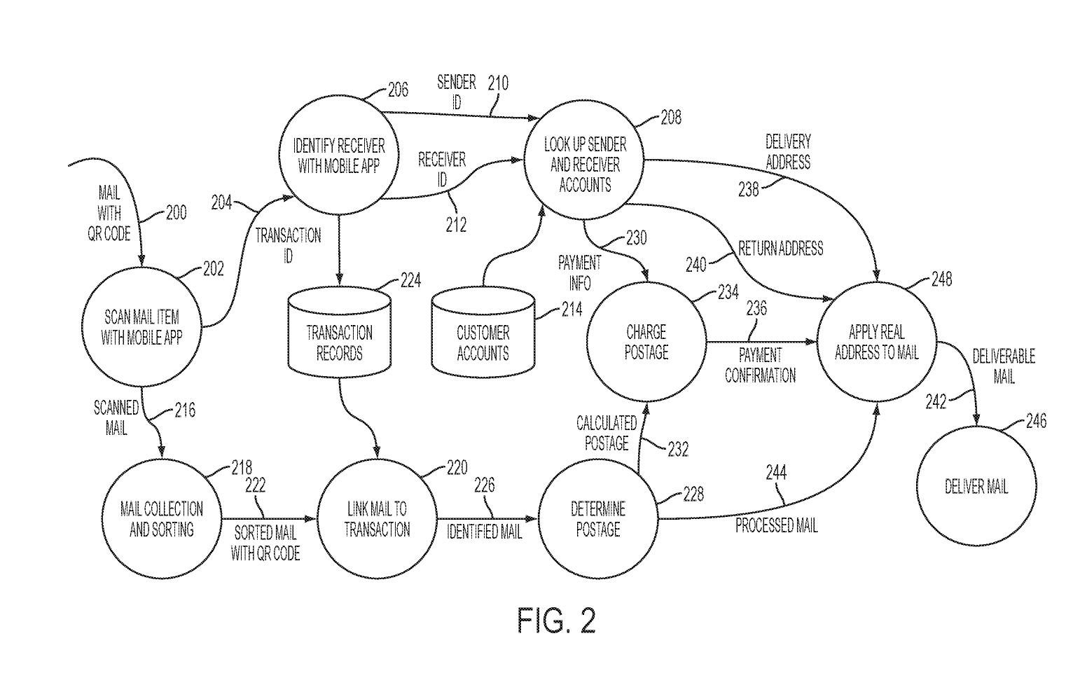

In exemplary embodiments where a recipient is identified without using an address, it may be that the physical address of the recipient is not known to the sender. In such a case, additional resources, such as a clearinghouse database system (see e.g., FIG. 2, step 208 and database 214, below) may be used to identify the physical address of the recipient. A code may be used to represent a physical address for the purposes of the sender, with the database system providing the physical address from the code. In exemplary embodiments, the physical address is not printed on the mail, but is instead used by the carrier up to and during delivery to a physical mailbox or address. In exemplary embodiments, a change of address is handled behind the scenes, with senders (e.g., bulk mailers) unaware of address changes (or the recipient's address at all), with the mail being automatically routed to a recipient's current address.

In exemplary embodiments, any additional charges associated with a change of address could be confirmed and paid by the sender or recipient. For example, a local mail from New York to Boston might have a new destination in Germany. The additional postage could be paid by the sender or recipient.

Referring now to FIG. 2 an exemplary, non-limiting flow chart is provided describing an exemplary implementation of processing of mail with a unique identifier. In this exemplary example, a specific example of an identifier (a QR code) will be referred to, as will be a particular mechanism of scanning such identifier, in this case, a mobile application (or “app”). However, it should be recognized that other identifiers and methods of scanning such identifiers may be used herein.

In step 200, an item of mail is generated with a QR code. At step 202, the identifier for the mail item is scanned using a mobile application. At step 204, a transaction ID is generated. At step 206, a mail recipient is identified with the mobile application. At step 208, sender and recipient identifications, 210 and 212 respectfully, are compared against a database 214 of customer accounts to positively identify sender and recipient information. In exemplary embodiments, the application associates the QR code (and by association, the mail) with a unique payment account through an on-demand, point-of use activation process, with the QR code remaining active until delivery.

At step 216, the scanned mail 202 is deposited with the carrier for mail collection and sorting, shown at 218. At step 220, sorted mail 222 with a QR code is compared against transaction records 224 (from the transaction identification 204 and identification of recipient 206) to link the mail to a transaction. In such a way, the carrier can automatically process the mail using the QR code. In exemplary embodiments, sorting and processing of mail may be facilitated by a variety of equipment, including scanners, mail bags, and virtual reality equipment, among others to identify the mail according to the QR code.

The identified mail 226 is processed to determine postage at step 228. Payment information 230 from the account determination step 208 and calculated postage 232 from the postage determination step 228 are utilized at step 234 in order to charge postage.

Payment confirmation 236 from the postal charge step 234, along with identified delivery and return addresses 238 and 240, respectively, are utilized to provide deliverable mail 242 from the processed mail 244. At step 246, deliverable mail 242 is delivered. Additionally, a real address may be applied at 248 to the mail.

According to yet another embodiment, the identifier is limited to a one-time use such that it is unique to the mail, the sender and the recipient. The one time use may be reflected by the uniqueness of the code or pattern. In exemplary embodiments, the identifier is never repeated. In exemplary embodiments where the identifier is a one-time use, information about the sender and/or recipient may be protected from exposure.

In other exemplary embodiments, for example where a code is printed by a sender, each mail transaction may utilize a unique identifier, e.g., a QR code, tailored to or identified with a sender and/or a recipient, along with a permutation to that identifier per transaction, but still retaining the sender and/or recipient association. In such a way, detailed tracking of plural transactions per sender, per recipient, or per sender/recipient pair over time may be facilitated.

In other exemplary embodiments, after a pre-determined period, or after direction to do so, the identifier is disassociated with the mail, sender and recipient such that it may be re-used with a new, specific mail, sender and recipient.

According to yet another embodiment, the carrier system identifies recipients according to the identifier and determines whether redirection is necessary based upon stored information about the recipient, e.g., updated address information, temporary or permanent. Additionally, such information may include preferences identified by the recipient, for example vacation re-routing information such as address and dates of vacation, recipient preferred contact information and other re-routing information. In such a way, an optimized processing carrier location may improve efficiency by eliminating the need to route the main according to the an optimized but inaccurate recipient address and instead directly route the mail to the proper location. Additionally, the system may be configured to indicate to the sender a confirmation of recipient availability at a particular address before deposit with the carrier. In other exemplary embodiments, the carrier system can be configured to print a first or updated recipient address on the mail during processing.

According to yet another embodiment, digital copies of the mail are provided either with the mail or via email in parallel with the mail. In such exemplary embodiments, digital copies provided with the mail may comprise a digital copy that is receivable through scanning of the identifier or other code. Such an embodiment may be useful where a particular recipient email address is not readily available. In such a case, the scanning of the code may allow for downloading of the digital copy. Alternately, the digital mail can be embedded in the identifier itself or linked to a document in the cloud, secured by cryptography and unlocked by a received key (e.g., at a mobile application at a recipient device) or otherwise, thus not requiring the use of email. In one example, a printed insurance card may be accompanied by encrypted digital paper works (e.g., rather than sending a thick policy document), digital paper coupons, etc. Attachment of a digital copy to physical mail may be useful where a sender does not have a valid or preferred email or other mobile address for the recipient, or where a recipient has not provided such information.

According to yet another embodiment, augmented reality and/or a smart mailbox may be used to facilitate sorting and delivery of mail. For example, a VR glass technology (e.g., Google Glass™ or Hololen™ type technology) may be used to scan the identifier to automatically provide information to the delivering carrier personnel relevant delivery information. Additionally a smart mailbox can confirm proper delivery or alert the carrier to incorrectly delivered mail. Further, a smart mailbox itself can scan the identifier and notify the recipient (including where desired a particular recipient within a household) of such delivery, relay a digital copy if not already relayed, etc. Where delivered by drone, the drone may also include scanning or virtual reality equipment. GPS information may also be associated with an address or compared against a delivery address for additional correct delivery confirmation.

According to other exemplary embodiments, the present system and method provide additional advantages to the carrier, including automated sorting, account charging (e.g., automatic account charging utilizing a service, such as EZPass Postage), accurate receiver address identification (e.g., consistent address identification), address change notification to a sender, granular tracking (e.g., receiver and sender notification and certified mail functionality) and label-less mail handling, e.g., via augmented reality hardware. Further exemplary advantages include: safeguarding of account and address information, among other information, through the use of the identifier, which is activated only when it is used; compatibility with current carrier systems (i.e., the ability to co-exist with non-identifier based delivery of mail; additional augmented tracking, with delivery confirmation, current mail progress tracking (or at least a last seen indicator) and early mail forwarding; reduced cost compared with current systems that require stamps or other specialized equipment; the ability to associate the identifier with a recipient, rather than with a destination address, including improved efficiency in mail handling (such as mail redirection from the deposit carrier location rather than a destination carrier location and other automated processing); and other fine grain control over mail, with possible sender and other information access through the digitized information.

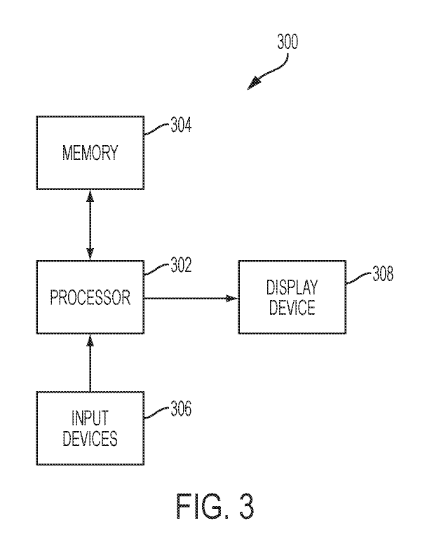

Furthermore, according to an example embodiment, the methodologies described hereinbefore may be implemented by a computer system or apparatus. For example, FIG. 3 illustrates a computer apparatus 300, according to an exemplary embodiment. Therefore, portions or the entirety of the methodologies described herein may be executed as instructions in a processor 302 of the computer system 300. The computer system 300 includes memory 304 for storage of instructions and information, input device(s) 306 for computer communication, and display device(s) 308. Thus, the present invention may be implemented, in software, for example, as any suitable computer program on a computer system somewhat similar to computer system 300.

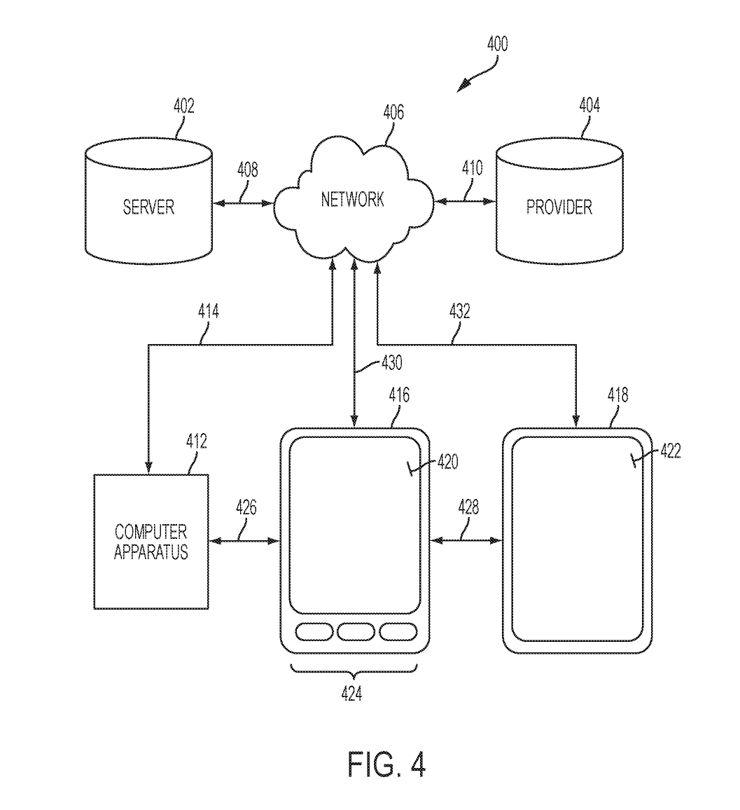

FIG. 4 is an example system for identifying, coordinating and managing mail, according to an example embodiment. The system 400 may include a server 402. The server 402 may include a plurality of information, including but not limited to, mail processing data, transaction ID data, data concerning senders, recipients and account information, computer executable code, or any other suitable information.

The system 400 may also include a service provider 404 in communication with the server 402 over a network 406. It is noted that although illustrated as separate, the service provider 404 may include a server substantially similar to server 402. The service provider may be a data service provider, for example, a cellular service provider, a an informational database providing transactional records (as shown at 224 in FIG. 2), account information or address related information (as shown in 214 in FIG. 2), a positioning service provider (satellite information, WiFi network position information, etc), or any other suitable provider. The service provider 404 may also be an application server providing applications and/or computer executable code implementing any of the interfaces/methodologies described herein. The service provider 404 may present a plurality of application defaults, choices, set-ups, and/or configurations such that a device may receive and process the application accordingly. The service provider 404 (or indeed, the server 402) may present any application (such as a mobile application, as has been described herein) on a user interface, web-browser of a device for relatively easy selection by a user of the device. The user interface or web-page rendered for application selection may be in the form of an application store and/or application marketplace.

The network 406 may be any suitable network, including the Internet, wide area network, mobile network, and/or a local network. The server 402 and the service provider 404 may be in communication with the network 406 over communication channels 408, 410. The communication channels 408, 410 may be any suitable communication channels including wireless, satellite, cellular, wired, or otherwise.

The system 400 further includes computer apparatus 412 (see also computer system 300 in FIG. 3) in communication with the network 406, over communication channel 414. The computer apparatus 412 may be any suitable computer apparatus including a personal computer (fixed location), a laptop or portable computer, a personal digital assistant, a cellular telephone, a portable tablet computer, or otherwise. For example, the system 400 may include computer apparatuses 416 and 418, which in this example are embodied as a smartphone and a wireless device such as a tablet, respectively. The apparatuses 416 and 418 may include display means 420, 422, and/or buttons/controls 424. The controls 424 may operate independently or in combination with any of the controls noted above. For example, the controls 424 may be controls directed to cellular operation or other wireless operations.

Further, the apparatuses 412, 416, and 418 may be in communication with each other over communication channels 426, 428 (for example, wired, wireless, Bluetooth channels, etc); and may further be in communication with the network 406 over communication channels 414, 430, and 1432.

Therefore, the apparatuses 412, 416, and 418 may all be in communication with one or both of the server 402 and the service provider 404, as well as each other. Each of the apparatuses may be in severable communication with the network 406 and each other, such that the apparatuses 412, 416, and 418 may be operated without constant communication with the network 1002 (e.g., using data connection controls of an interface). For example, if there is no data availability or if a user directs an apparatus to work offline, an application, e.g., a scanning function, at any of the apparatuses 412, 416, and 418 may be based on stored information/parameters, with subsequent application processing once network connectivity has been reestablished. It follows that each of the apparatuses 412, 416, and 418 may be configured to perform the methodologies described above.

An exemplary system includes multiple components, including a unique ID (identifier), mail packaging or label including such identifier, a scanner for the identifier, for example a smartphone or tablet with a camera and scanning software such as a QR code reader, an application, e.g., implemented on a mobile device such as a smart phone or tablet (it should be recognized that the application itself may include scanning software); a server in communication with the application to provide additional information and to facilitate processing of mail, as has been described herein; and carrier hardware, such as a scanner, smart mail bags, augmented reality, smart mailboxes, etc., as has also been described herein.

In exemplary embodiments, the sender and optionally the recipient utilize one or more applications or have established accounts in accordance with the present disclosure. Such applications may communicate with a server or service provider that host user account information, which may be set up using the application or via accessing an online source. In exemplary embodiments, account information may include any type of information, including payment information, address information and the like, without limitation. Account information access by a server, service provider or user application may be authorized in full or in part by any account owner.

In exemplary embodiments, the application may be configured to allow a sender to select (e.g., from a database) or enter a recipient or an address and to enter other mail handling parameters, as has been discussed herein. In other exemplary embodiments, a recipient implementation of an application may be configured to receive notice of a mailing or intended mailing and to permit the recipient to provide further information, to correct information or to provide additional requests, as have been described herein. Such application implementations may allow, with or without server and associated database resources, to provide server and recipient discovery, auto correction of an address, confirmation of receiver availability, correction of information, or other aspects described herein.

In exemplary embodiments, the server or service provider identifies the mailing transaction, the unique identifier, the parties involved and any changes or application of addresses or further instructions. Further exemplary embodiments provide for controlled access to such information, i.e., such that names, addresses and account information are not readily apparent, but instead are tied to the identifier. As we have also described, the system may be configured in exemplary embodiments such that: redirection occurs at an optimized carrier location rather than a destination location; the carrier may additionally print human readable information, such as an address, on the mail; augmented reality equipment may be utilized to decipher the identifier and to determine the delivery address, without requiring it to be in human readable form; GPS and/or smart mailbox technology may be utilized to confirm delivery or to indicate improper delivery; and digital or other copies may be generated by the carrier and/or a smart mailbox according to delivery preferences.

In exemplary embodiments, a unique identifier and associated information can be protected by a special security mechanism. This security mechanism can limit the information retrievable by different user. For example, the unique identifier provides the payment account information to the post office, but the payment account is not available to the recipient. The digital version of the mail is available to a particular recipient in a household, while the mail carrier cannot access it. In this example, the payment account information are encrypted by a mechanism accessible by the post office automated machinery. The digital version of the mail is protected in an online account that only the recipient has login information.

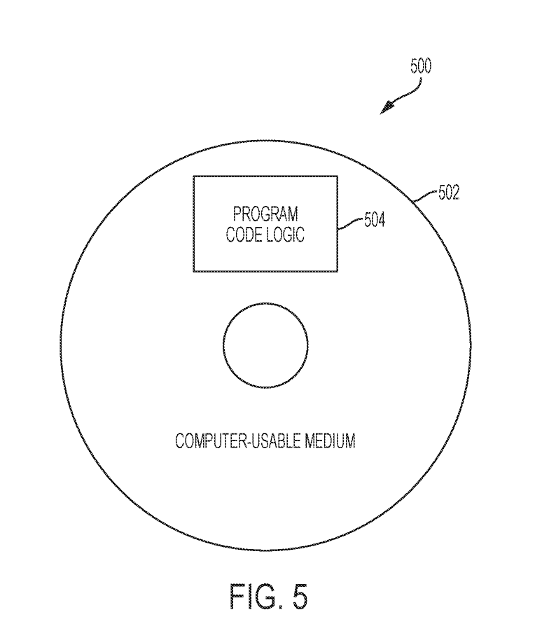

A program in accordance with the present invention may be a computer program product causing a computer to execute the example methods described herein. Thus, example embodiments may include a computer program product 500 as depicted in FIG. 5 on a computer usable medium 502 with computer program code logic 504 containing instructions embodied in tangible media as an article of manufacture. Exemplary articles of manufacture for computer usable medium 502 may include floppy diskettes, CD-ROMs, hard drives, universal serial bus (USB) flash drives, or any other computer-readable storage medium, wherein, when the computer program code logic 504 is loaded into and executed by a computer, the computer becomes an apparatus for practicing the invention. Embodiments include computer program code logic 504, for example, whether stored in a storage medium, loaded into and/or executed by a computer, or transmitted over some transmission medium, such as over electrical wiring or cabling, through fiber optics, or via electromagnetic radiation, wherein, when the computer program code logic 504 is loaded into and executed by a computer, the computer becomes an apparatus for practicing the invention. When implemented on a general-purpose microprocessor (e.g., 302), the computer program code logic 504 segments configure the microprocessor to create specific logic circuits.

The computer-readable storage medium may be a built-in medium installed inside a computer main body or removable medium arranged so that it can be separated from the computer main body.

Further, such programs, when recorded on computer-readable storage media, may be readily stored and distributed. The storage medium, as it is read by a computer, may enable the method(s) disclosed herein, in accordance with an exemplary embodiment of the present invention.

Therefore, the methodologies and systems of example embodiments of the present invention can be implemented in hardware, software, firmware, or a combination thereof. Embodiments may be implemented in software or firmware that is stored in a memory and that is executed by a suitable instruction execution system. These systems may include any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of at least one example embodiment of the present invention in which functions may be executed out of order from that shown or discussed, including substantially concurrently or in reverse order, depending on the functionality involved, as would be understood by those reasonably skilled in the art of the present invention.

Any program which would implement functions or acts noted in the figures, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium, upon which the program is printed, as the program can be electronically captured, via for instance optical scanning of the paper or other medium, then compiled, interpreted or otherwise processed in a suitable manner if necessary, and then stored in a computer memory. In addition, the scope of the present invention includes embodying the functionality of the preferred embodiments of the present invention in logic embodied in hardware or software-configured mediums.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for identifying, coordinating and managing mail, comprising:
identifying mail packaging according to a unique identifier, the unique identifier linking the mail to a payment account, a sender and a recipient;
identifying said recipient; and
processing deposited mail by a carrier, wherein said processing includes:
recognizing the unique identifier;
calculating postage for the mail;
charging said postage to said payment account; and
routing the mail to the recipient, wherein a sender application or an optimized processing carrier location determines a final delivery address or determines whether address redirection is necessary or desired in order to properly route the mail to the recipient.

2. A method in accordance with claim 1, wherein a sender application or an optimized processing carrier location provides a pre-delivery notification to the recipient and determines whether address redirection is necessary or desired in order to properly route the mail to the recipient.

3. A method in accordance with claim 1, wherein said unique identifier is a QR code, which is activated by scanning thereof by a sender and which becomes inactive after delivery or after a pre-determined period.

4. A method in accordance with claim 1, wherein said unique identifier is scanned by a sender utilizing a mobile application.

5. A method in accordance with claim 1, wherein said processing comprises scanning said unique identifier by a carrier and identifying sender and recipient information associated with said unique identifier.

6. A method in accordance with claim 5, wherein said calculating and charging of postage are performed at an optimized processing carrier location after assessment of said mail and after determination of a final delivery address and requested options.

7. A method in accordance with claim 1, wherein said processing includes requests for digital or other copies of mail, in addition to delivery of physical mail.

8. A method in accordance with claim 1, wherein said mail or unique identifier includes an accessible link to a digital copy of some or all information related to said mail.

9. A method in accordance with claim 1, wherein said processing includes use of smart or augmented reality by the carrier to identify, to confirm delivery of or to provide additional digital or other copies of mail information to a recipient.

10. A system for identifying, coordinating and managing mail comprising:
a sender application configured to identify a mail packaging according to a unique identifier, the unique identifier linking the mail to a payment account, a sender and a recipient; and
a carrier server configured to retrieve information linked to said unique identifier during processing of the mail, identify the recipient, calculate of postage of the mail, charge the postage to the payment account and route the mail to the recipient, wherein a sender application or an optimized processing carrier location determines a final delivery address or determines whether address redirection is necessary or desired in order to properly route the mail to the recipient.

11. A system in accordance with claim 10, wherein a sender application or said carrier server at an optimized processing carrier location is configured to provide a pre-delivery notification to the recipient and to determine whether address redirection is necessary or desired in order to properly route the mail to the recipient.

12. A system in accordance with claim 10, wherein said unique identifier is a QR code, and wherein said system is configured to activate said QR code by scanning of a sender, and further wherein the system is configured to deactivate said QR code after delivery or after a pre-determined period.

13. A system in accordance with claim 10, wherein a mobile application is configured to scan said unique identifier.

14. A system in accordance with claim 10, wherein said carrier server is configured to process said unique identifier by scanning said unique identifier and identifying sender and recipient information associated with said unique identifier.

15. A system in accordance with claim 14, wherein said carrier server is configured to calculate and charge postage at an optimized processing carrier location after assessment of said mail and after determination of a final delivery address and requested options.

16. A system in accordance with claim 10, wherein said carrier server is configured to process mail by facilitating requests for digital or other copies of mail, in addition to delivery of physical mail.

17. A system in accordance with claim 10, wherein said mail or unique identifier includes an accessible link to a digital copy of some or all of the information related to said mail.

18. A system in accordance with claim 10, wherein said carrier server is configured to process mail with smart or augmented reality devices to confirm delivery of or to provide additional digital or other copies of mail information to a recipient.

19. A computer program product including a computer readable medium containing computer executable code thereon, wherein the computer executable code, when processed by a processor of a computer, directs the processor to perform a method of r identifying, coordinating and managing mail according to the method, comprising:
identifying mail packaging according to a unique identifier, the unique identifier linking the mail to a payment account, a sender and a recipient;
identifying said recipient; and
processing deposited mail by a carrier, wherein said processing includes:
recognizing the unique identifier;
calculating postage for the mail; and
charging said postage to said payment account; and
routing the mail to the recipient, wherein a sender application or an optimized processing carrier location determines a final delivery address or determines whether address redirection is necessary or desired in order to properly route the mail to the recipient.

20. A computer program in accordance with claim 19, wherein said processing comprises scanning said unique identifier by a carrier and identifying sender and recipient information associated with said unique identifier and wherein said calculating and charging of postage are performed at an optimized processing carrier location after assessment of said mail and after determination of a final delivery address and requested options.

21. A computer program in accordance with claim 19, wherein a sender application or an optimized processing carrier location provides a pre-delivery notification to the recipient and determines whether address redirection is necessary or desired in order to properly route the mail to the recipient.

22. A computer program in accordance with claim 19, wherein said unique identifier is a QR code, which is activated by scanning thereof by a sender and which becomes inactive after delivery or after a pre-determined period.

23. A computer program in accordance with claim 19, wherein said processing includes requests for digital or other copies of mail, in addition to delivery of physical mail.

24. A computer program in accordance with claim 19, wherein said mail or unique identifier includes an accessible link to a digital copy of some or all information related to said mail.

25. A computer program in accordance with claim 19, wherein said processing includes use of smart or augmented reality by the carrier to identify, to confirm delivery of or to provide additional digital or other copies of mail information to a recipient.
